(19) United States
(12) Patent Application Publication
(10) Pub. No.: US 2017/0024804 A1
(43) Pub. Date: Jan. 26, 2017

(54) SYSTEMS AND METHODS FOR MULTI-CHANNEL FULFILLMENT OF ONLINE RETAIL ORDERS

(71) Applicant: HEB Grocery Company, LP, San Antonio, TX (US)

(72) Inventors: Paul Steven Tepfenhart, JR., San Antonio, TX (US); Kedar Dilip Patel, San Antonio, TX (US); Joshua Frank Morales, San Antonio, TX (US); William Andrew Chancellor, JR., Pleasanton, TX (US); Tiffany Brooke Doege, San Antonio, TX (US); Melissa Mary Ryan, San Antonio, TX (US); Elizabeth Ann Bonilla, San Antonio, TX (US)

(21) Appl. No.: 14/807,588

(22) Filed: Jul. 23, 2015

(51) Int. Cl. G06Q 30/06

(52) U.S. Cl. CPC G06Q 30/0635

(57) ABSTRACT

Systems and methods for receiving and processing online orders for items and/or services to be fulfilled by the retailer using multiple different fulfillment channels or methods for multiple items in a single order are provided. In certain embodiments, the methods comprise: receiving data regarding a plurality of items selected for purchase from a retailer by a customer in an order, wherein one or more possible fulfillment channels are associated with each of the items; assigning a fulfillment channel for each of the items in the order, wherein at least two different fulfillment channels are assigned within the order; receiving payment information from the customer for the order; and retrieving and/or preparing the items in the order for fulfillment to the customer via at least two different fulfillment channels.

### BACKGROUND

The present disclosure generally relates to systems and methods for receiving, processing, and fulfilling online orders for items and/or services sold by retailers.

For a number of years, online shopping over the Internet has grown increasingly popular for both business and personal use as more merchants offer goods and services through associated websites. Normally, with an Internet based shopping system, a customer accesses a website, views products and/or services and associated specifications, chooses a product and/or service for purchase, selects a delivery option, provides delivery and credit card payment information and authorizes a purchase transaction.

Electronic commerce or online shopping systems for groceries are also available. However, many such systems are inefficient, fail to provide satisfactory customer interfaces, or are otherwise problematic. First, many existing electronic commerce or online shopping systems are used and tailored primarily for business providing goods out of a distribution center, while most grocery retailers still operate and provide many goods predominantly through “brick-and-mortar” stores. Indeed, certain types of “fresh” or made-to-order items such as floral arrangements, bakery goods, deli goods, and the like that are prepared for specific customers “in-store” and/or perishable items may not be well suited for delivery to customers via distribution center channels. However, the personnel and systems for these different retail channels do not (and often cannot) interact with online inventory systems, ordering systems, and customer interfaces in the same way. Thus many retailers who provide goods via multiple delivery channels have simply chosen to operate those channels separately from one another. However, this may provide a less than satisfactory shopping experience for a customer. Shipping or delivery of grocery items to a customer at their home can also be difficult since, for example, once an order for grocery items is placed, often items (e.g., produce) cannot be shipped in their original packaging and therefore, require special handling and repackaging. Further, often a commercial delivery service does not exist that fulfills the needs of an online grocery shopping system. Therefore, the delivery must be provided by the supplier of the electronic commerce shopping system, and most often, such a supplier has little or no delivery capability and even less knowledge regarding how to execute an efficient delivery system.

### SUMMARY

The present disclosure generally relates to systems and methods for receiving, processing, and fulfilling online orders for items and/or services sold by retailers, and more particularly, to systems and methods for receiving and processing online orders for items and/or services to be fulfilled by the retailer using multiple different fulfillment channels or methods for multiple items in a single order.

In certain embodiments, the present disclosure provides methods comprising: receiving data regarding a plurality of items selected for purchase from a retailer by a customer in an order, wherein one or more possible fulfillment channels are associated with each of the items; assigning a fulfillment channel for each of the items in the order, wherein at least two different fulfillment channels are assigned within the order; receiving payment information from the customer for the order; and retrieving and/or preparing the items in the order for fulfillment to the customer via at least two different fulfillment channels.

In other embodiments, the present disclosure provides computer programs stored in a tangible medium for accepting and processing online retail orders comprising a plurality of instructions that when executed cause at least one processor to: receive data regarding a plurality of items selected for purchase from a retailer by a customer in an order, wherein one or more possible fulfillment channels are associated with each of the items; assign a fulfillment channel for each of the items in the order, wherein at least two different fulfillment channels are assigned within the order; receive payment information from the customer for the order; and create a request for retrieval and/or preparation the items in the order for fulfillment to the customer via at least two different fulfillment channels.

In other embodiments, the present disclosure provides online retail systems comprising: a data server that comprises at least one processor, a communications interface configured to receive data from one or more client systems, and a memory comprising executable instructions that, when executed, cause the at least one processor to: receive data regarding a plurality of items selected for purchase from a retailer by a customer in an order, wherein one or more possible fulfillment channels are associated with each of the items; assign a fulfillment channel for each of the items in the order, wherein at least two different fulfillment channels are assigned within the order; receive payment information from the customer for the order; and create a request for retrieval and/or preparation the items in the order for fulfillment to the customer via at least two different fulfillment channels.

The features and advantages of the present disclosure will be apparent to those skilled in the art. While numerous changes may be made by those skilled in the art, such changes are within the spirit of the invention and disclosure.

### BRIEF DESCRIPTION OF THE FIGURES

Some specific example embodiments of the disclosure may be understood by referring, in part, to the following description and the accompanying figures.

FIGS. 1 through 12 are representations of displays from an online retail website that may be used in accordance with certain embodiments of the present disclosure.

FIG. 13 is a diagram that depicts an online retail system according to certain embodiments of the present disclosure.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION OF EMBODIMENTS

The present disclosure generally relates to systems and methods for receiving, processing, and fulfilling online orders for items and/or services sold by retailers.

More particularly, the present disclosure provides systems and methods for receiving and processing online orders for items and/or services to be fulfilled by the retailer using multiple different fulfillment channels or methods (e.g., home delivery, ship-to-home, ship-to-store, in-store pick-up) for multiple items in a single order. In the methods of the present disclosure, a customer selects a plurality of items for purchase in a single order from a retailer via an online interface such as an Internet website, software application on a computer or mobile device, or the like. One or more possible fulfillment channels are associated with each of the items selected by the customer, which may be presented to the customer via the online interface. A fulfillment channel is then assigned to each of items in the order by the user or the retailer (or automatically by a server operating the online order system), with at least two different fulfillment channels being selected or assigned for different items in a single order. Once fulfillment channels have been selected or assigned for each item in the order, the order can be further processed for payment and confirmation. The items in the order may then be retrieved and/or prepared for fulfillment to the customer via at least two different fulfillment channels. In the methods of the present disclosure, the customer provides payment and confirmation for all items in a single order (i.e., items being fulfilled via at least two different fulfillment channels) substantially or substantially simultaneously through a single online interface. The present disclosure also provides computer programs stored in a tangible medium comprising a plurality of instructions that when executed cause at least one processor to perform some or all of the methods described herein. The present disclosure also provides systems that are configured to receive and process online retail orders using multiple different fulfillment channels according to the methods described herein.

In many embodiments, retailers using or providing the methods and systems of the present disclosure both (1) own and/or operate one or more “brick-and-mortar” retail stores and/or physical locations where customers may browse, purchase, and/or pick up items at the site, and (2) provide an online web site or other service for receiving orders from customers remotely. In the methods and systems of the present disclosure, retailers may provide the requested or ordered goods or services to the customer via any suitable fulfillment method, channel, or option known in the art. Examples of fulfillment method or channels that may be used in certain embodiments include, but are not limited to, home delivery, ship-to-home, ship-to-store, and/or in-store pick-up. As used herein, the term “ship-to-store” refers to a fulfillment channel or method where, in response to an order for the item from a customer, the item is retrieved from inventory at a distribution center, warehouse, or retail store location (which may be a store designated as the pick-up location or a different store location) and shipped to or made available at a retail store or other pick-up location for pick-up by the customer. As used herein, the term “in-store pick-up” refers to a fulfillment channel or method where, in response to an order for the item from a customer, the item is prepared to order at a particular retail store or other pick-up location and may be picked up by the customer (which includes being picked up by a customer's agent or designee) at that location. In certain embodiments, such an agent or designee may be a representative or employee of a third-party courier, delivery, or shopping company authorized by the customer and/or retailer to pick up items ordered by the customer (either separately or through the third-party company) at the pick-up location. As used herein, the term “ship-to-home” refers to a fulfillment channel or method where, in response to an order for the item from a customer, the item is retrieved from inventory at a distribution center, warehouse, or retail store location and is delivered or shipped (e.g., via a third-party carrier such as United States Postal Service, UPS, etc.) to an address specified by the customer. As used herein, the term “home delivery” refers to a fulfillment channel or method where, in response to an order for the item from a customer, the item is prepared to order at a particular store or other location and is transported from that location to an address specified by the customer by the retailer. However, this listing of examples of fulfillment channels and their definitions is not limiting, and the present disclosure contemplates and includes any suitable fulfillment channel that may be known now or in the future. For example, certain types of goods such as electronic gift cards, certificates, vouchers, books, music, or other goods or services in the form of electronic data files may be provided (e.g., delivered) to a customer via digital and/or electronic fulfillment methods including but not limited to e-mail, text messages, audio/video messaging, Internet-based communications, and the like. Moreover, the set of fulfillment methods or channels presented to a customer may be further simplified, for example, as simply providing the ordered items at the customer's “home” (or other address specified by the customer) or at a “store” or other location where the customer may pick up the items, while omitting any further details regarding the fulfillment channel.

Moreover, retrieving and/or preparing the items in an order for fulfillment may comprise any steps or actions performed by the retailer and/or its personnel before fulfillment. For example, in certain embodiments “retrieving” items may include picking the items from any facility or location operated by the retailer, including the retail area of a store, a store's stockroom, a distribution center, or the like. Examples of actions that may be deemed “preparing” the items include, but are not limited to collecting, making, cooking, assembling, weighing, tagging, packaging, arranging, customizing, and/or decorating the items, as well as other similar types of activities.

Among the many potential advantages to the methods and compositions of the present disclosure, only some of which are alluded to herein, the methods and systems of the present disclosure may provide a more efficient, cost-effective, and/or flexible means of delivering retail items to a customer from multiple sources of inventory operated by a single retailer. In some embodiments, the methods and systems of the present disclosure may provide customers greater variety and/or choice in methods of obtaining items purchased from a retailer, and may do so for multiple different items and methods of fulfillment in a single website, display, and/or transaction, providing greater convenience to the customer. In some embodiments, the methods and systems of the present disclosure may allow retailers and users to deliver and/or purchase multiple items in a single order from using the quickest and/or most cost-effective delivery channel available based on real-time data.

The retailers who may operate or use the methods and systems of the present disclosure may include any entity who sells and/or provides goods or services to customers, including but not limited to grocery retailers. The goods or items provided using the methods and systems of the present disclosure may include any suitable goods. In certain embodiments, the goods or items may comprise food or grocery items, including but not limited to pre-packaged food items, perishable food items (e.g., meat, produce, delicatessen items, bakery items, etc.), refrigerated or frozen food items, and the like. These goods or items may be purchased by the retailer from another source, or may be created, packaged, or prepared (in whole or in part) by the retailer. In some embodiments, the goods or items may be “made to order” and/or customized per the customer's request and/or specifications. In certain embodiments, the goods or items may be stored and/or provided as a part of the inventory of a retail store location, either in a stockroom or in the retail space accessible to customers at the store.

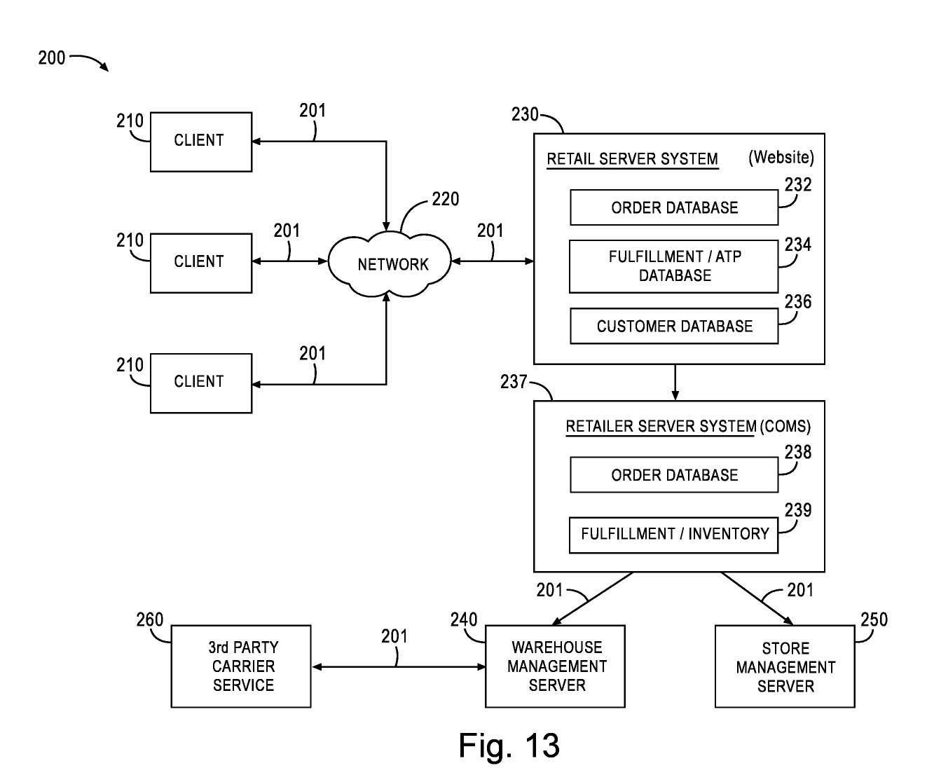

FIG. 13 illustrates an example system 100 for implementing an online retail order management system according to certain embodiments of the present disclosure. This system involves a system configured for client-server interaction and communication, which refers to a distributed system in which a program at one site sends a request to a program at another site and waits for a response. The requesting program is called the “client,” and the program which responds to the request is called the “server.” Client-server systems may exist in the Internet (which refers to a collection of interconnected (public and/or private) networks that are linked together by a set of standard protocols (such as TCP/IP and HTTP) to form a global, distributed network), the World Wide Web, or other networks either public or private in nature. While this term may refer to what is now commonly known as the Internet, it is also intended to encompass variations which may be made in the future, including changes and additions to existing standard protocols. In the context of the Internet or the World Wide Web, the client is a “Web browser” (or simply “browser”) which runs on a computer of a user; the program which responds to browser requests by serving Web pages is commonly referred to as a “Web server.” A website or retailer server system of the present disclosure serves informational content over a network, typically using the standard protocols of the World Wide Web.

The drawings illustrate an online retail order management system of the present disclosure and the operation thereof implemented using the World Wide Web. However, those skilled in the art will recognize that the methods and systems of the present disclosure could also be implemented in other fashions. For instance, the online retail order management system of the present disclosure could be implemented using standard Internet and World Wide Web protocols through other commercial on-line providers or through a private hosting service or network. Alternatively, the online retail order management system of the present invention could be implemented using proprietary protocols over either a public or private network, or could be implemented entirely within a single computing facility. In addition, although the online retail order management system disclosed herein embodies several different inventive features, it will be recognized that any one of these features could be implemented without the others. Further, although the inventive features are described in the context of the sale of products, it will be recognized that the features could be used to facilitate transactions involving other types of items, such as securities, livestock, and various types of services.

System 200 includes one or more client systems 210 used by a customer, and a retailer server system for running a website 230 connected to each other by a network 220. A retail server system for management of customer orders 237 is also connected to the server system 230. Although FIG. 13 illustrates a particular arrangement of client systems 210, retailer server systems 230 and 237, and network 220, this disclosure contemplates any suitable arrangement of client system(s) 210, retailer server systems 230 and 270, and network 220. As an example and not by way of limitation, two or more of client system 210 and a retailer server system 230 may be connected to each other directly, bypassing network 220. As another example and not by way of limitation, two or more of client system 210, retailer server system 230, and retailer server system 237 may be physically or logically co-located with each other in whole or in part. Moreover, although FIG. 13 illustrates a particular number of client systems 210 and retailer server systems 230 and 237, and networks 220, this disclosure contemplates any suitable number of client systems 210, retailer server systems 230 and 237, and networks 220. As an example and not by way of limitation, system 200 may include multiple client systems 210, retailer server systems 230 and 237, and networks 220. System 110 also may comprise any number of intermediate servers and/or networks between one or more of client systems 210, retailer server systems 230 and 237, and networks 220. For example, the data provided to client systems 210 for display to a customer and/or data provided to retail server system 230 and/or 237 may be processed or passed through one or more additional servers or computer systems hosted by a third party Web site provider. Such intermediate servers and/or networks may run additional software or further process data received from client systems 210 and/or retailer server systems 230 and 237 before transmission of that data elsewhere in the system.

Server systems used in the methods and systems of the present disclosure such as retailer server systems 230 and 237 generally comprise at least one processor, a memory that may comprise executable instructions for the processor, and a communications interface configured to transmit data to and receive data from other computer systems or devices. The processor may comprise any microprocessor, central processing unit (“CPU”), or other computer processors known in the art, and the communications interface may comprise any type of computer interface device known or used in the art with electronics and computer systems, including but not limited to modems, Ethernet/Wi-Fi/LAN/cellular adapters, serial connections, data bus connections, and other similar types of devices. The processor may include an internal memory device and/or be configured to access a separate memory device or drive comprising executable instructions. Data servers suitable for use in the retailer server systems in the present disclosure include those commercially available from Dell, IBM, and Apple. The retailer server systems also may include multiple redundant servers that operate as mirrors of each other, which may, among other purposes, increase speed of the system and/or help compensate for failures or other problems in the servers.

In particular embodiments, retailer server systems 230 and 237 may be network-addressable computing systems that can host one or more retailer's server systems. Retailer server systems 230 and/or 237 may host data accessible to the public on a website, and may generate, store, receive, and transmit various types of data relating to online orders, including but not limited to item-related data (e.g., images, pricing, inventory availability, perishability, customization options, size/weight data, promotional information, and/or other attributes), customer-related data (e.g., names, addresses, phone numbers, e-mail addresses, communication preferences, purchase histories, payment information, etc.), data relating to third-party carriers (e.g., shipment costs, shipment times, etc.), store-related data (e.g., addresses, store departments, inventory, etc.) and the like. In the embodiment shown, retailer server system 230 may store and process various types of data and perform various tasks relating to the website where online orders are placed. For example, as shown in FIG. 13, retailer server system 230 may include an order database 232 that stores data records for orders for items placed by a customer on a website using system 200. Retail server system 230 also may include a fulfillment/“available to promise” inventory database 234 that stores information relating to the item availability (e.g., by various dates), inventory information, and/or available fulfillment channels for items that may be ordered through system 200. In some embodiments, retail server system 230 also may include a customer database 236 that stores information relating to particular customers that have placed orders on a website using system 200 and/or have otherwise submitted personalized customer information (e.g., a user profile or registration) to the retailer. In other embodiments, the retail server system 230 may access databases on other server systems hosted by third-parties, including but not limited to third-party databases containing item-related data (e.g., images, pricing, inventory availability, perishability, customization options, size/weight data, promotional information, and/or other attributes), customer-related data (e.g., names, addresses, phone numbers, e-mail addresses, communication preferences, purchase histories, payment information, etc.), data relating to third-party carriers (e.g., shipment costs, shipment times, etc.), and the like.

In the embodiment shown, retailer server system 237 may store and process various types of data and perform various tasks relating to the fulfillment of orders that have already been placed. For example, as shown in FIG. 13, retailer server system 237 may include an order database 238 that stores data records for orders to be fulfilled. Retail server system 237 also may include a fulfillment/inventory database 239 that stores information relating to the item availability, inventory information, and/or available fulfillment channels for items that may be needed to fulfill orders placed through system 200 (as well as other orders or inventory requirements of the retailer). In certain embodiments, retail server system 237 may comprise additional databases (not shown) that include information regarding product sourcing from third parties, including capacity information, shipment scheduling information, and third-party inventory information for various products.

The retailer server systems 230 and 237 may be accessed by the other components of system 200, either directly or via network 220. In particular embodiments, one or more customers may use one or more client systems 210 to access, send data to, and receive data from retailer server systems 230 and 237. A client system 210 may access retailer server systems 230 and 237 directly, via network 220, or via a third-party system.

A client system 210 may include any suitable computing device, such as, for example, a personal computer, a laptop, a cellular phone, a smartphone, a personal digital assistant, an ultra-mobile PC, a computing tablet, a gaming console, TV set top box/interface, a kiosk, or the like. These devices may be owned by a customer or user, or alternatively may include computing devices available to the public or otherwise provided by a third party (e.g., the retailer) for a customer's use. Such devices may be provided and/or used at any location, including at a store location operated by a retailer. In particular embodiments, computer system includes a processor, a memory (RAM/ROM) that comprises executable instructions for the processor, and a communication interface. In certain embodiments, suitable computer systems may comprise storage, an input/output (I/O) interface, communication buses, and other components. This disclosure contemplates any suitable computer system having any suitable number of any suitable components in any suitable arrangement. The client system may include, incorporate, or interface with various types of input and output devices. Suitable output devices may include, but are not limited to, display monitors, audio speakers, printers, or the like. Suitable input devices may include, but are not limited to, touch screens, mouses, microphones, keyboards, or the like.

Network 220 may be any suitable communications network. As an example and not by way of limitation, one or more portions of network 220 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 220 may include one or more networks 220.

System 200 also may include one or more warehouse management servers 240 that are configured to generate, store, receive, and transmit various types of data relating to items stored at warehouses or distribution centers owned or operated by a retailer. In particular, in certain embodiments of the present disclosure, warehouse management servers 240 may receive and/or process requests for items ordered by a customer that are to be fulfilled via a ship-to-home or ship-to-store method. In certain embodiments, warehouse management server 240 may be connected to one or more other servers or computer systems (not shown) located at one or multiple warehouses or distribution centers (either at the same site as the server, or at a remote location), which may be used to facilitate the retrieval and/or preparation of the requested items for shipment. The warehouse management server also may be connected to one or more third-party carrier servers 260, among other reasons, in order to facilitate the transmission of data relating to shipments that the retailer intends to provide to the third party retailer for delivery to a customer.

System 200 also may include one or more store management servers 250 that are configured to generate, store, receive, and transmit various types of data relating to items located, stored and/or prepared at retail store locations owned or operated by a retailer. In particular, in certain embodiments of the present disclosure, store management servers 250 may receive and/or process requests for items ordered by a customer that are to be fulfilled via a delivery and/or in-store pick-up method. In certain embodiments, store management server 250 may be connected to one or more other servers or computer systems (not shown) located at one or more retail store locations (either at the same site as the server, or at a remote location), which may be used to facilitate the retrieval and/or preparation of the requested items for pick-up by and/or delivery to the customer. For example, in certain embodiments, the store management server 250 may route requests to a computer system for a designated store, and/or may route requests for items in particular categories to a specialized department within a store (e.g., floral, deli, bakery, etc.).

Connections 201 may connect client systems 210, retailer server system 230, communication network 220, warehouse management servers 240, store management servers 250, and/or third party carrier servers 260 to each other. This disclosure contemplates any suitable connections 201. In particular embodiments, one or more connections 201 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 201 each include an ad hoc network, an intranet, an extranet, a VPN, a LAN, a WLAN, a WAN, a WWAN, a MAN, a portion of the Internet, a portion of the PSTN, a cellular telephone network, another connection 201, or a combination of two or more such connections 201. Connections 201 need not necessarily be the same throughout system 200. One or more first connections 201 may differ in one or more respects from one or more second connections 201.

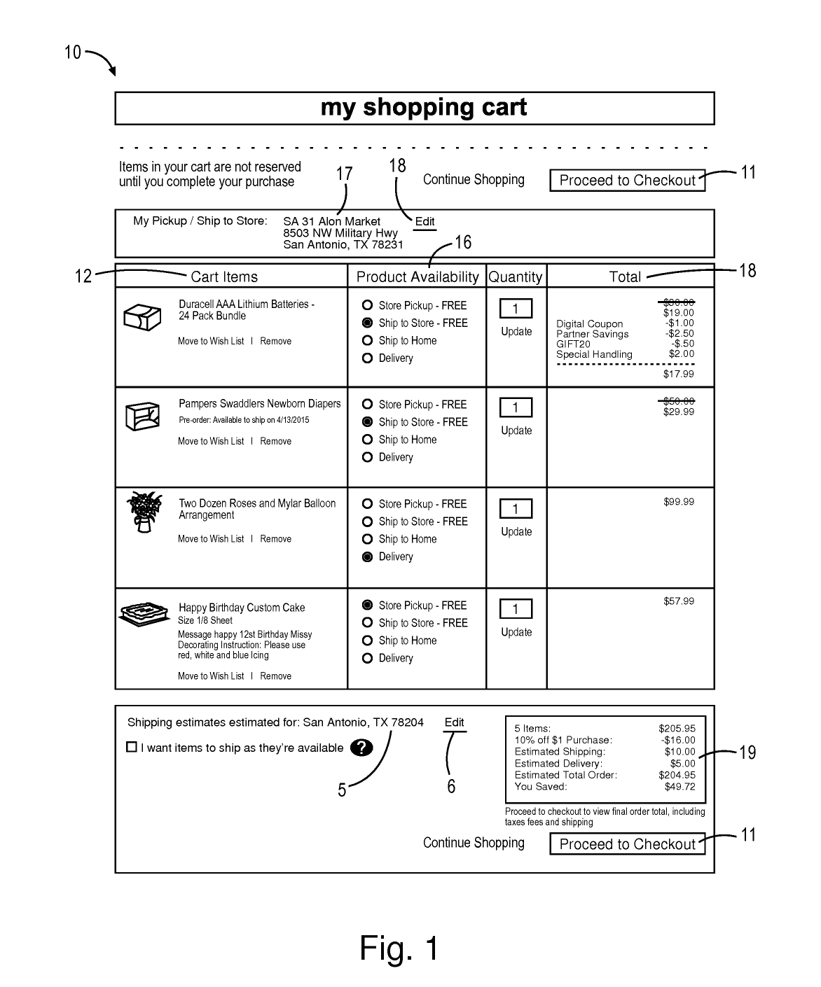

FIGS. 1-12 illustrate the display of Web pages that may be generated and/or sent by a retailer's server system (or a third party vendor's server system on the retailer's behalf) to a client system operated by a customer where a customer can use or access them for ordering and/or purchasing items from the retailer according to certain embodiments of the present disclosure. As a person of ordinary skill in the art will recognize, various elements of these displays and pages may be altered, moved, omitted, optimized, supplemented, re-formatted (e.g., for different types of client systems and/or devices), re-ordered, and/or re-distributed amongst various pages and still accomplish the methods disclosed herein. It is within the spirit and scope of this disclosure to make such modifications to the examples of displays and pages described herein.

Referring now to FIG. 1, a display of a virtual shopping cart from an online retail system according to certain embodiments of the present disclosure is shown. The shopping cart display 10 includes a listing 12 for each of a plurality of items in an order, each of which may include various pieces of information about the item (e.g., name, size, images, etc.). For each item 12, there is also provided a quantity counter 16 indicating how many of the item are in the customer's cart, a pricing block 18 indicating the price of the item(s) 12, and a product availability block 14 which lists available fulfillment options or channels for each item 12. In the embodiment shown in FIG. 1, the items in the cart include four different fulfillment options. However, in other embodiments, there may be more or fewer fulfillment options shown. For example, in some embodiments, the display 10 may merely include fulfillment options for “store” or “home”, wherein the “store” option would apply to items fulfilled via either in-store pick-up or “ship-to-store” channels and the “home” option would apply to items fulfilled via either home delivery or “ship-to-home” channels. Such a configuration may simply the interface for the customer and/or provide greater flexibility for the retailer in some embodiments.

In the embodiment shown in FIG. 1, each fulfillment option includes a radio button (or other type of manipulable selector suitable for interactive interfaces in client systems) that may be selected by a customer to assign a fulfillment channel for each item 12. In most cases, only one fulfillment option may be selected at a time for each item 12, and the display will show only the fulfillment options available for a particular item (or, alternatively unavailable fulfillment options for an item may be “shaded” out or their respective radio buttons may be inactive). Available fulfillment options for each item may be stored in a product catalog database that is accessed by the online retail system. In some embodiments, the pricing information shown in pricing block 18 may be higher or lower depending on the fulfillment option selected (and/or may be blank until a fulfillment option is selected). In certain embodiments, these radio buttons may be left blank until a customer selects one. In certain embodiments, these fulfillment options may be selected by the customer (or assigned by the system, as described below) at any point in time before proceeding to checkout for the order, as described below. For example, the fulfillment option for an item may be selected as the customer adds the item to the order. In other embodiments, the fulfillment options for each item may be selected or assigned once the customer has added all items to the order.

In other embodiments, the retailer's system may assign a “default” fulfillment option for certain items 12 (or all items). The “default” fulfillment option for an item may be assigned based on various rules or criteria set by the retailer and/or the customer. For example, in some embodiments, the fulfillment options for all items may be placed in a set order (e.g., in the embodiment shown, in the order of “in store pick-up”, followed by “ship to store”, followed by “ship to home”, followed by “delivery”), and the system may automatically assign to an item a default fulfillment option that is simply the first available option in that order.

In other embodiments, the system may assign a default fulfillment option based on algorithms having inputs for one or more data fields, including but not limited to the location of the customer, the location of inventory, shipping speeds, third-party carrier availability/costs, item size/weight, item perishability, and the like. Of course, the fulfillment options selectable according to these embodiments may be limited, for example, by a customer's preference. For example, if the customer indicates that he wants the item delivered to their home, the system may be configured to evaluate only ship-to-home or delivery fulfillment options/methods. Alternatively, if the customer indicates that he wants to pick up the item from a store, the system may be configured to evaluate only ship-to-store or in-store pick-up fulfillment options/methods.

In certain embodiments, the system may be configured to assign a default fulfillment option for an item or group of items representing the least cost fulfillment channel, which may be determined by the system using one or more algorithms, an example of which is described below. For example, when a customer adds one or more items to the virtual shopping cart, the system may determine the set of locations where the item(s) is or can be provided (e.g., retailer store inventory, retailer distribution center inventory, third-party distribution center inventory, etc.), and may look up and/or calculate one or more costs associated with fulfilling the item from one or more of those locations (by each of the set of fulfillment options available for that location) in order to determine the location and fulfillment channel for the item(s) that presents the least net impact on the retailer's gross margin for the item. In certain embodiments, the system may determine subtract one or more costs associated with the storage, fulfillment, and/or shipping of each item from each of the locations from the retail price paid by the customer for the item to yield the item's fulfillment margin associated with that location and fulfillment channel. For example, the fulfillment cost of the item may include estimated labor costs and/or other costs associated with picking, packing, or otherwise preparing the item. In another example, the shipping cost may be calculated by estimating transportation costs for the retailer to deliver the item to the delivery location provided by the customer and/or looking up shipping rates from a third-party carrier based on the item location and a delivery location provided by the customer. In this example, any shipping costs to be passed along to the customer may be ignored or omitted from the calculation described above.

If a customer's order includes only a single item, the system may compare the item's fulfillment margins calculated for each of the locations and select the location (and associated fulfillment channel) associated with the highest fulfillment margin, which would comprise the least cost fulfillment channel for the order. If the order includes multiple items, the system may evaluate the possible combinations of fulfillment channels for the items by summing the fulfillment margins for the items using those combinations. This may involve determining the locations where each of the items in the customer's virtual cart or order (or some subset thereof) are available, and selecting the location that has the highest total fulfillment margin, which corresponds to the least cost fulfillment channel for those items in the order. In some embodiments, for items to be shipped and/or delivered to a location other than retail store, the system may be configured to take into account the additional costs associated with the number and/or weight of boxes needed to accommodate all of the items. For example, in these embodiments, the cost savings for shipping or delivering a set of items from a single location where they can be boxed together may produce a new total fulfillment margin that exceeds the total fulfillment margin for the set of items calculated as described above. The system according to the present disclosure may take these costs into account in selecting the fulfillment channel for a set of items in the customer's order.

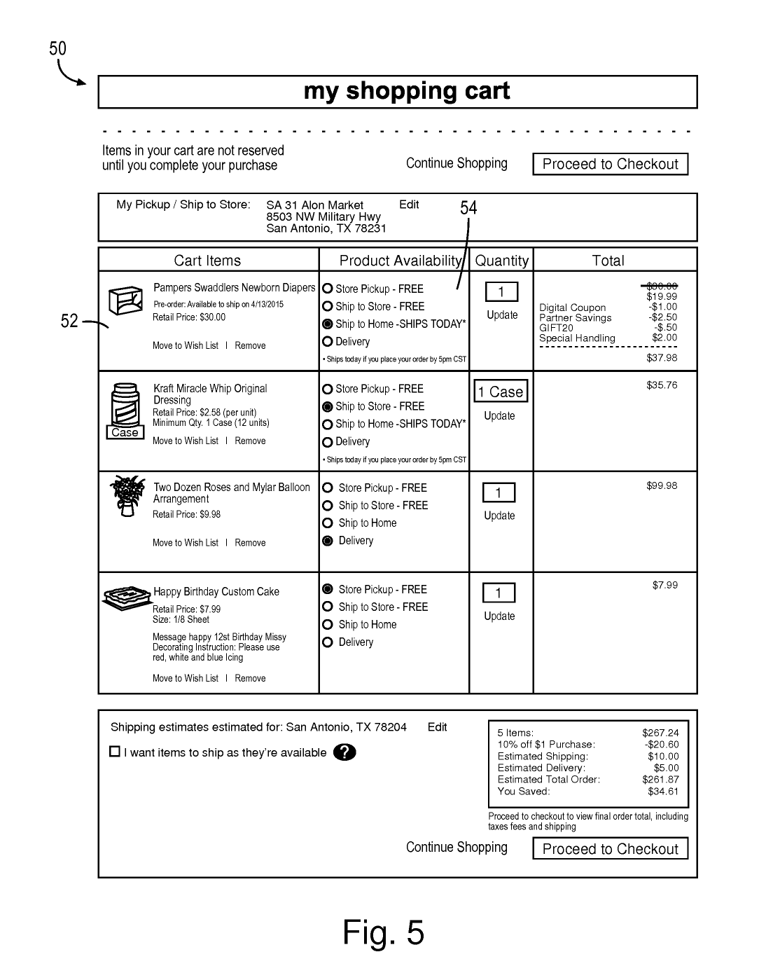

As shown in FIG. 1, in certain embodiments, certain of the fulfillment options for certain items may be visually highlighted, emphasized, or flagged in product availability block 14 with various attributes (e.g., additional text indicating “FREE”), among other reasons, to further inform the customer about details of those options and/or to encourage the user to select them. The highlighting and/or emphasis for a particular fulfillment option for a particular item may be static (i.e., always appearing for that particular item and fulfillment option) or may change depending on one or more additional pieces of information relating to the customer (e.g., location, customer profile registration, and/or other customer preferences), other items in the cart (e.g., the number and/or total cost of items in the cart), the item's inventory, and the like. For example, in some embodiments, when the shopping cart display 10 is refreshed (e.g., when changes are made to the contents/options for the shopping cart, or when a customer refreshes the shopping cart display in his browser), the client system may send some or all of the information displayed relating to items in the shopping cart to the retail server system. At that time, the retail server system may confirm that the items and requested quantities of items are in stock and available for the various fulfillment options displayed. In certain embodiments, the retailer system also may confirm whether the items (including the quantity of those items) in the customer's shopping cart have corresponding inventory that is designated in the retailer's server system as being available for shipping to a store location and/or to a customer's home on the same day that the customer places his order. As shown in FIG. 5, any such items (e.g., item 52) in the customer's shopping cart may be highlighted in product availability block 54 of shopping cart display 50 with a message “SHIPS TODAY” next to the applicable fulfillment option. A message indicating a cutoff time for the order to be placed in order for an item to ship on the same day also may be displayed reflecting a cutoff time associated with that item's availability in the retail server system or inventory database. As a person skilled in the art with the benefit of this disclosure will recognize, a system of the present disclosure could also be configured to check inventory databases in the retailer's server system for other information relating to the timing of shipping (e.g., the earliest available shipping date) and display that information in product availability block 54 instead.

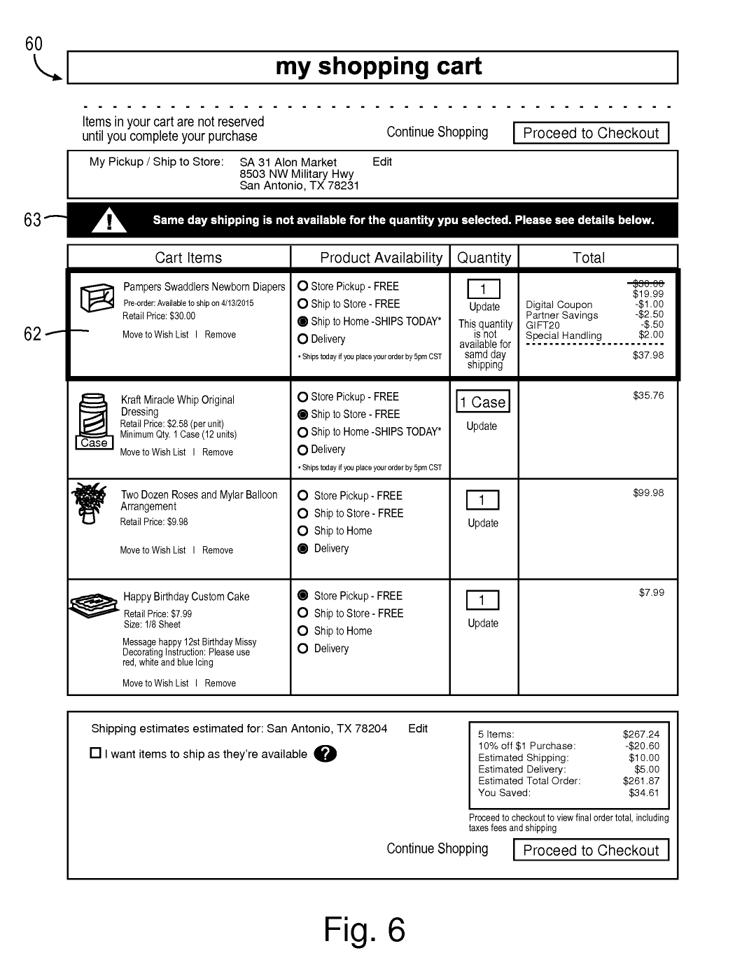

The item information and shipping availability as discussed above may be re-sent to the retailer server system and updated on display 50 as the customer makes changes to his cart and the client system refreshes display 50. If a customer previously selected a fulfillment option previously highlighted with a “SHIPS TODAY” designation (or other designation) but the item (or quantity of that item) becomes unavailable for same day shipping before the customer completes his order, display 50 from FIG. 5 may be updated, as shown in FIG. 6. Referring now to FIG. 6, in display 60, the item 62 that is no longer available for same day shipping may be visually highlighted or flagged, and a message 63 may be displayed informing the customer that an item in the cart is no longer available for same day shipping.

In certain embodiments, if a customer selects a “delivery” radio button for one of the items 12 in the shopping cart display 10, the retailer's system may prompt the customer to input information relating to the delivery location and/or desired delivery date for the item (if that information was not provided when the item was placed in the cart). This information also may allow the retailer to confirm whether the item is available for delivery at the desired location and/or date. Such a display may take on any suitable form for allowing a customer to input such information, which are known in the art. Such a display may be displayed on the client system in the same browser window as display 10 (either replacing display 10 or as a “pop-up” in the foreground while display 10 remains visible but inactive in the background) or in a separate browser window.

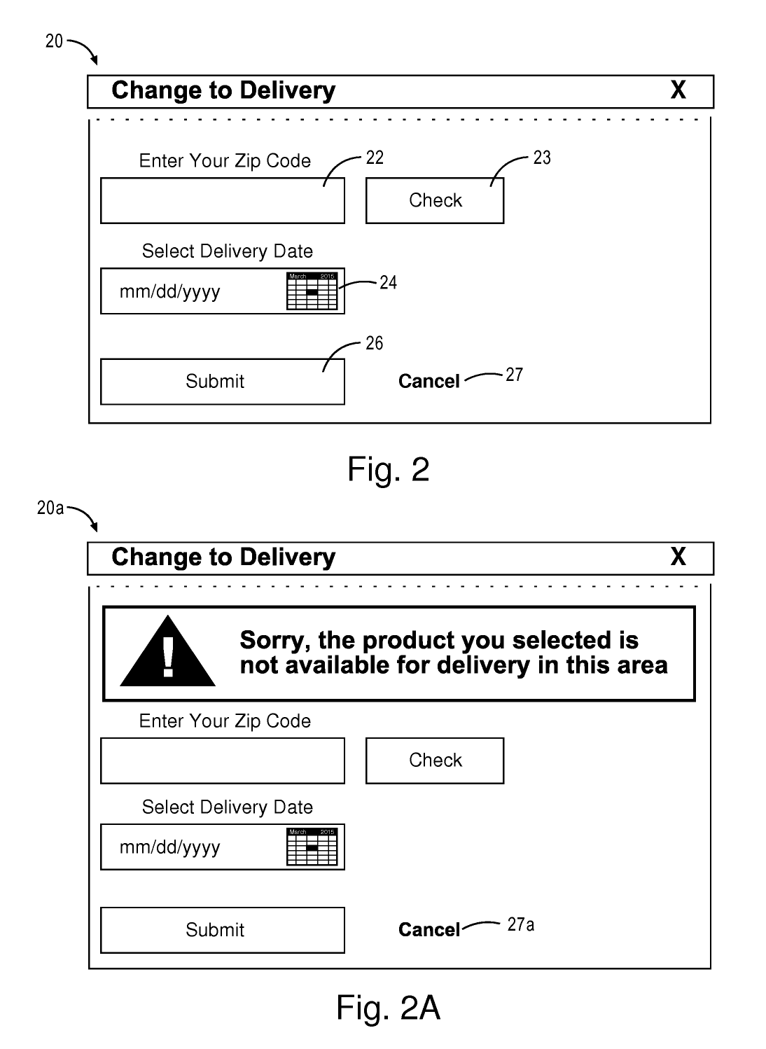

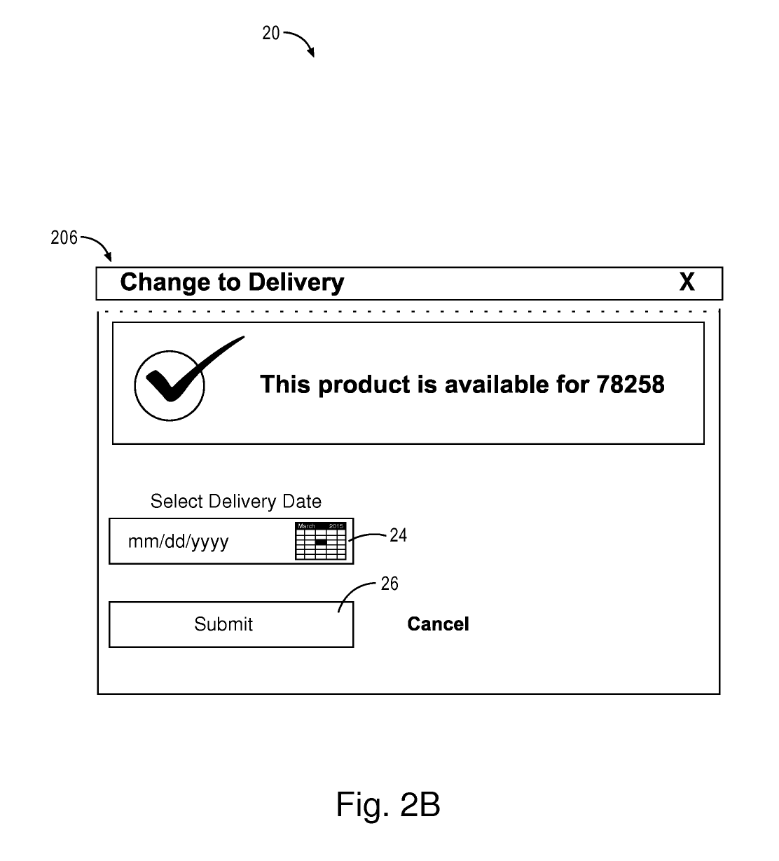

An example of a display for allowing the customer to provide information relating to delivery location and/or desired delivery time/window is shown in FIG. 2. FIG. 2 shows a display 20 that includes a zip code field 22 where a customer may input the postal zip code where the item is to be delivered. In some embodiments, this field 22 may be automatically populated with zip code information associated with a customer's past purchase history and/or registered account with the retailer (to which the customer has “logged in” for the session in which the order is being created). In other embodiments, the zip code field 22 may be automatically populated based on location data provided to the retailer system by the customer's client system or device. Alternatively, display 20 may include fields (not shown) that allow a user to input more detailed information about the location, such as a specific address and/or location type (e.g., business, residential, etc.).

A zip code check button 23 may be displayed near the zip code field 22 that, when clicked by the customer, may send the zip code information to the retailer's system and prompt the system to confirm whether the item 12 is available for delivery in the specified zip code (e.g., based on item inventories, proximity of stores with delivery services, and/or other such factors). If the retailer's system confirms that item 12 is not available for delivery in the specified zip code, display 20a as shown in FIG. 2A may be displayed on the client system, communicating that information to the customer, allowing the customer to either enter a different zip code or click the “cancel” button 27a to return to shopping cart display 10. If the retailer's system confirms that item 12 is available for delivery in the specified zip code, display 20b as shown in FIG. 2B may be displayed on the client system, communicating that information to the customer. The customer may also enter or choose a delivery date using the delivery date field 24 (in FIGS. 2, 2A, and/or 2B), either by entering a date in text/numeric form or by using a calendar-based date picker known in the art that displays available dates. In some embodiments, after a date is selected, further options (not shown) may be displayed for selecting a more specific delivery time/window on the selected date.

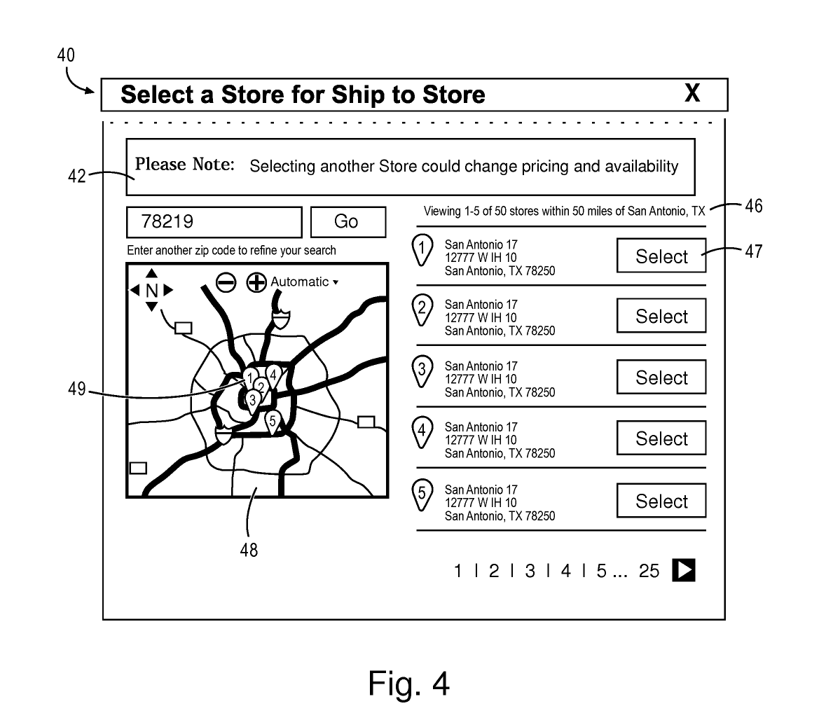

Shopping cart display 10 also may include a store location listing 17 indicating a particular store location associated with a particular order. This store location may be selected by the customer at any time before proceeding to checkout with the items in the virtual cart. The store location may be selected by any suitable means. In some instances, the store location may be selected by the customer for a particular order, or may represent a store location associated with a customer's past purchase history and/or registered account with the retailer (to which the customer has “logged in” for the session in which the order is being created). In other embodiments, the store location may be automatically selected by the retailer's system, for example, based on location data provided to the retailer system by the customer's client system or device. In certain embodiments, this store location listing 17 may be suppressed in display 10 if the customer and/or the retailer system has assigned either a “ship-to-home” or “home delivery” channel for all items in the virtual cart, or if the customer and/or the retailer system has not assigned a “ship-to-store” or “in-store pick-up” channel for any item in the virtual cart. A store location edit hyperlink 18 also may be displayed near the store location listing 17, which may be clicked or activated by the customer to choose a different store location than the location shown (for example, via the display in FIG. 4, which is described in further detail below). As used herein, a “hyperlink” refers to a navigational link from one display to another, or from one portion (or component) of a display to another. Typically, a hyperlink is displayed as a highlighted word or phrase that can be selected by clicking on it using a mouse or touching a touch-screen display in the area of the word or phrase to jump to the associated display or documented portion.

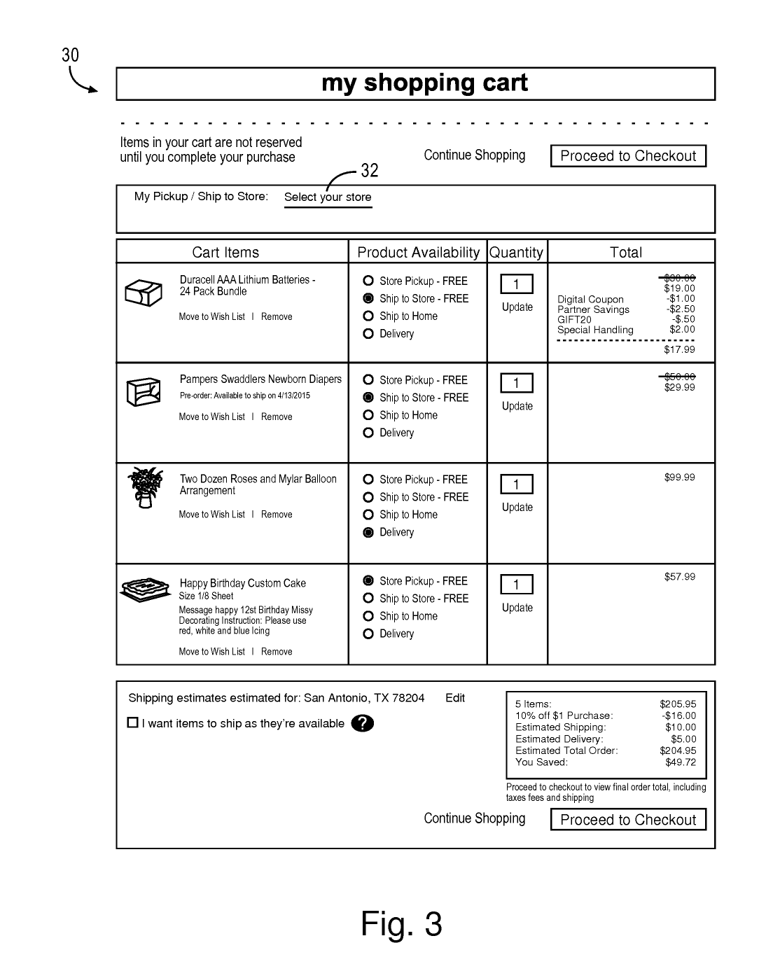

FIG. 3 illustrates an alternative embodiment of shopping cart display 10 of FIG. 1. Display 30 includes many of the same elements as display 10, but does not list a store location associated with the order. Instead, display 30 includes a “Select a Store” hyperlink 32, which may be clicked or activated by the customer to choose a different store location In certain embodiments, this “Select a Store” hyperlink 32 may be suppressed in display 30 if the customer and/or the retailer system has assigned either a “ship-to-home” or “home delivery” channel for all items in the virtual cart, or if the customer and/or the retailer system has not assigned a “ship-to-store” or “in-store pick-up” channel for any item in the virtual cart.

In certain embodiments, clicking store location edit hyperlink 22 in FIG. 1 or “Select a Store” hyperlink 32 in FIG. 3 may cause the client system to show a different display with options for selecting a store location to be associated with the order. In certain embodiments, a display for selecting a store location to be associated with the order also may be displayed if a customer's cart includes items for which a “ship-to-store” or “in-store pick-up” fulfillment channel has been selected, but there is no store location associated with the order (for example, as shown in FIG. 3), and the customer clicks the “Proceed to Checkout” button 11. In certain embodiments, a display for selecting a store location to be associated with the order also may be displayed if no store location associated with the order (for example, as shown in FIG. 3), and the customer clicks one of the radio buttons for “ship-to-store” or “in-store pick-up” for an item. Such a display may take on any suitable form for allowing a customer to select a retailer store location, which are known in the art. In some embodiments, such a display may simply include a listing of store locations, some or all of which may be store locations associated with a customer's past purchase history and/or registered account with the retailer (to which the customer has “logged in” for the session in which the order is being created).

An example of a display for allowing the customer to select a store location for fulfillment of items via in-store pick-up or “ship-to-store” channels is shown in FIG. 4. FIG. 4 shows a display 40 that includes a zip code field 42 where a customer may input the zip code where it wishes to search for nearby store locations. Alternatively, display 40 may include fields (not shown) that allow a customer to input more detailed location information for searching for nearby store locations (e.g., a specific address) and/or specify other store location preferences. In some embodiments, zip code field 42 may be automatically populated with zip code information associated with a customer's past purchase history and/or registered account with the retailer (to which the customer has “logged in” for the session in which the order is being created). In other embodiments, the zip code field 42 may be automatically populated based on location data provided to the retailer system by the customer's client system or device. When the “Go” button 44 is clicked, the zip code information in field 42 may be sent to the retailer's system (or a third-party site), and one or more retail store locations in or within a set distance of the zip code entered by the customer may be identified (using any suitable method) and displayed in display 40 in a store locations list 46 and/or a store locations map 48. As is known in the art, the store locations map 48 may be interactive, allowing the customer to narrow, broaden, and/or change the map view and/or the geographic scope of the search by clicking or activating one or more elements on the display 40. Once search results are displayed, a customer may select a specific store location either by clicking or activating its respective “Select” button 47 (or the store listing itself, if the display 40 is configured to allow that interaction) in the store locations list 46 or its flag indicator 49 on the store locations map 48. Once a specific store location is selected, the client system may return to display 10 as shown in FIG. 1, which will then display the selected or updated location in store location listing 17.

Referring back to FIGS. 1 and 3, displays 10 and 30 also include listings 19 of the total cost (price) for all of the items in the cart as well as their total shipping and/or delivery costs. Displays 10 and 30 also include a shipping zip code listing 5, which may indicate a zip code associated with the order where items to be fulfilled via “ship-to-home” or “ship-to-store” channels will be shipped. The shipping zip code 5 may be used, among other purposes, to calculate estimated delivery dates, calculate estimated shipping costs, and/or to determine whether the shipment of the requested item(s) is locally or otherwise prohibited in the requested location (e.g., lithium batteries). The shipping zip code 5 may be selected by the customer at any time before proceeding to checkout with the items in the virtual cart. The shipping zip code 5 may be selected by any suitable means. In some instances, the shipping zip code may be selected by the customer for a particular order, or may represent a shipping zip code associated with a customer's past purchase history and/or registered account with the retailer (to which the customer has “logged in” for the session in which the order is being created). In other embodiments, the shipping zip code 5 may be automatically selected by the retailer's system, for example, based on location data provided to the retailer system by the customer's client system or device. In certain embodiments, this shipping zip code listing 5 may be suppressed in display 10 or 30 if the customer and/or the retailer system has assigned either a “home delivery” or “in-store pick-up” channel for all items in the virtual cart, or if the customer and/or the retailer system has not assigned a “ship-to-store” or “ship-to-home” channel for any item in the virtual cart. A shipping zip code edit hyperlink 6 also may be displayed near shipping zip code listing 5, which may be clicked or activated by the customer to choose a different shipping zip code than the zip code shown.

Displays 10 and 30 also include one or more “Proceed to Checkout” buttons 11. In certain embodiments, when “Proceed to Checkout” button 11 is clicked or activated by the user, the online system may temporarily suspend the customer's ability to add items to the cart and/or change their quantities and/or assigned fulfillment channels. Clicking or activating button 11 also may prompt the retailer's system to perform one or more functions to further process the order. In most embodiments, clicking the “Proceed to Checkout” button 11 may send information relating to all of the items in the customer's shopping cart at that time (e.g., item, quantity, selected fulfillment channel) to the retailer system. The retailer system may use this information, for example, to confirm that the items and requested quantities of items are in stock and available for the selected fulfillment channel. In certain embodiments, the retailer system also may retrieve dates for fulfillment of each item in the cart at this time. In certain embodiments, if one or more items are not available for fulfillment as indicated in the shopping cart display 10, or if one more pieces of information needed to verify item availability have not been provided, the retailer system may send information the client system causing it to display an error message and/or additional displays informing the customer that one or more items are not available and/or prompting the customer to provide additional information so that the items' availability may be confirmed.

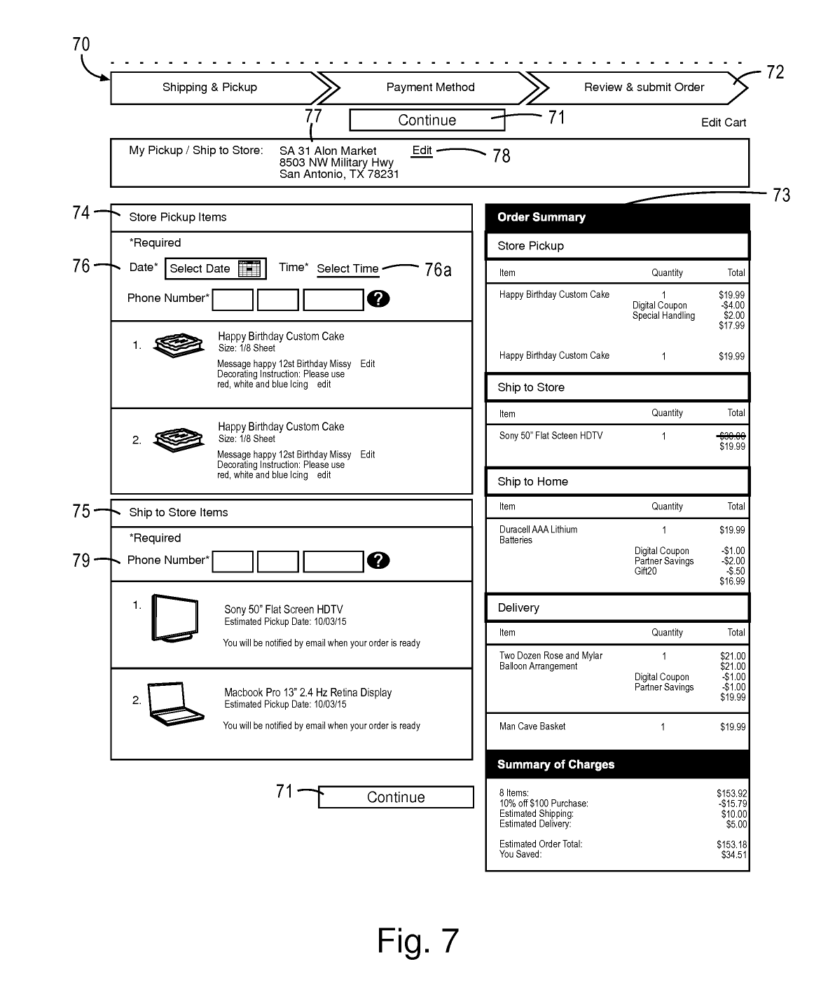

Once the retailer system has confirmed that all items in shopping cart display 10 are available for fulfillment as requested, the retailer system may generate and send one or more displays relating to fulfillment checkout details for each of the items in the customer's cart/order. Examples of such checkout displays 70, 80, and 90 are shown in FIGS. 7, 8, and 9, respectively. Checkout displays 70, 80, and 90 each include an order summary section 73, 83, or 93 in one portion of the display that shows all of the items in the customer's order grouped by their selected fulfillment channels, including limited information about each of those items, and the total cost for all of the items in the cart as well as their total shipping and/or delivery costs. The information displayed in order summary sections 73, 83, and 93 may be updated as the customer makes changes and inputs information in displays 70, 80, and 90 and the displays are refreshed or changed. Checkout displays 70, 80, and 90 also each includes one or more “Continue” buttons 71, 81, or 91 that, when clicked or activated by the customer, cause the client system to send the information input into fields on current display to the retailer server system, re-confirm availability of all items in the order for their designated fulfillment channels, and generate the next display for processing of the order.

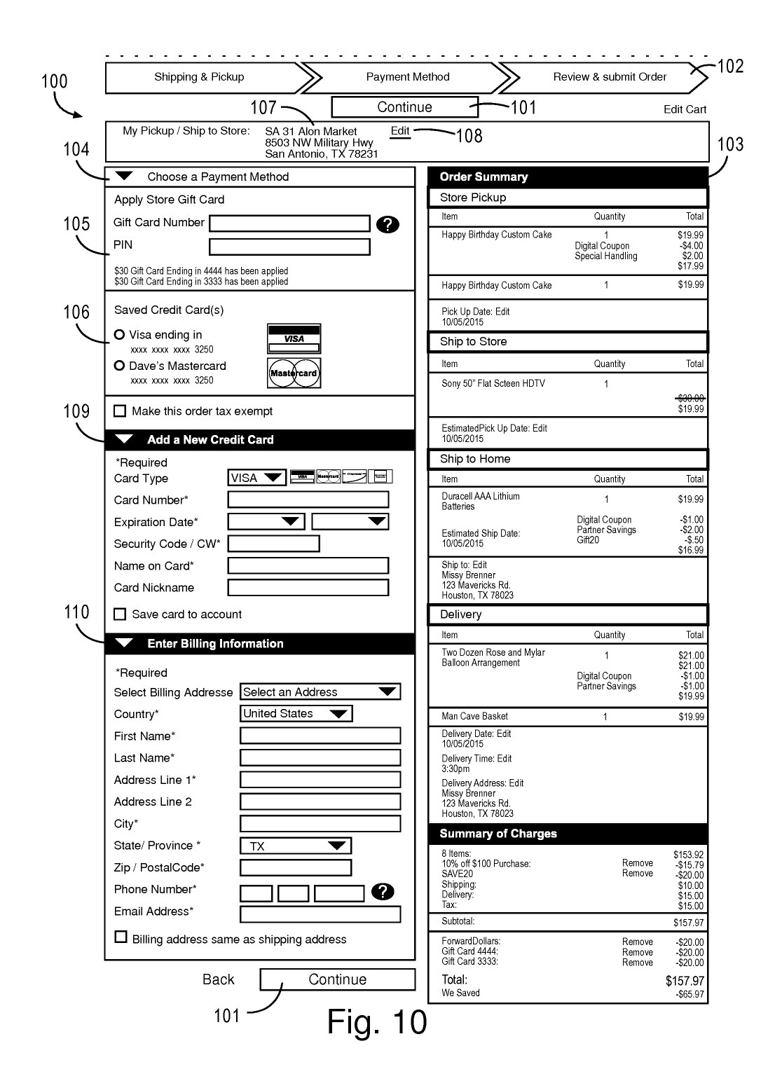

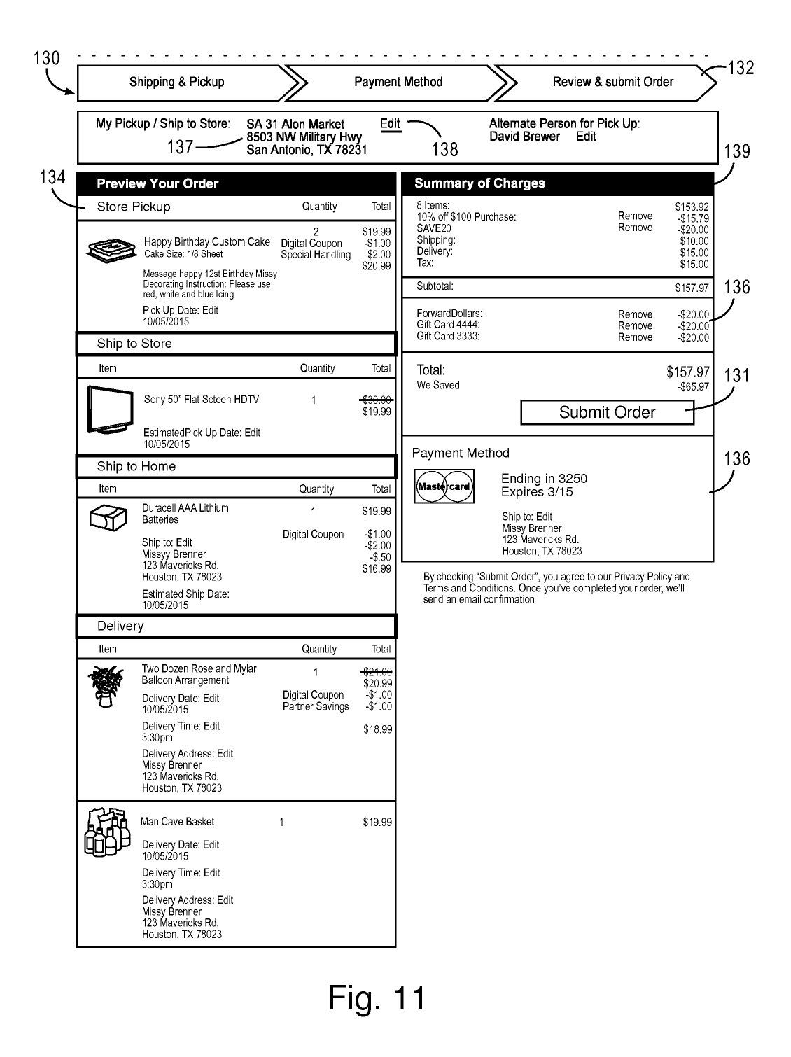

Checkout displays 70, 80, and 90 also each include a progress bar 72, 82, or 92 that reflect one or more steps in the checkout process and indicate the customer's progress in completing those steps. In the embodiment shown, progress bars 72, 82, and 92 include three steps: (a) “Shipping & Pick-up”, where the customer may be asked to provide or confirm more detailed information regarding the fulfillment channels for each of their items (FIGS. 7-9), (b) “Payment Method”, where the customer may be asked to provide or confirm payment information for the order (FIG. 10), and (c) “Review & Submit Order”, where the customer has the opportunity to review all of the item, payment and fulfillment information options for all of the items in their order and confirms submission of the order to the retailer server system for processing and fulfillment (FIG. 11).

Referring now to FIG. 7, checkout display 70 further includes active areas 74 and 75 listing the items selected for in-store pick-up and ship-to-store fulfillment. Checkout display 70 also includes a store location listing 77 and an “Edit” hyperlink 78, which operate in a fashion similar to listing 17 and hyperlink 18 in FIG. 1. In certain embodiments, if the retail system server identified any items in the customer's shopping cart display 10 that were designated for in-store pick-up but are not available at the store location listed in display 10 after the customer clicked on the “Proceed to Checkout” button in FIG. 1, an error message may be added to display 70 informing the customer of this issue, and optionally prompting the customer to select another store location (e.g., using the “Edit” hyperlink 78, which may prompt the display of a display like that shown in FIG. 4) or remove items (using a hyperlink provided (not shown)). If a new store is selected at this stage, the client system will send the new store location and the customer's item information to the retail server system to confirm that all items designated for in-store pick-up are available at the new store location.

Areas 74 and 75 may include additional fields for customer input or other information relating to the items designated for in-store pick-up and ship-to-store fulfillment. For example, for ship-to-store items listed in area 75, an estimated pick-up date may be listed for each item (or a common date for the group of items, represented the date when all items will be available for pick-up) as well as further pick-up notification information. For items designated for in-store pick-up, the customer may enter or choose a pick-up date using the pick-up date field 76, either by entering a date in text/numeric form or by using a calendar-based date picker known in the art that displays available dates. In some embodiments, after a date is selected, a more specific pick-up time/window on the selected date may be selected. For example, clicking pick-up time hyperlink 76a on display 70 may prompt the client system to display (either in the same window or in a new window) available pick-up time options from which the customer may select.

In certain embodiments, the systems of the present disclosure may be configured to automatically send a text message, e-mail, recorded audio message, or other communication to the customer when the items in the order designated for in-store pick-up and ship-to-store fulfillment are ready to be picked up at the store location. In certain such embodiments, phone number fields 79 may allow a user to input a telephone number to associate with the group of items to be picked up from the store location. In some instances, a particular telephone number may be entered by the customer for a particular order, or may be automatically populated with telephone number information associated with a customer's past purchase history and/or registered account with the retailer (to which the customer has “logged in” for the session in which the order is being created). This telephone number also may be used by retailer personnel to update or follow up with a customer if a problem with their order occurs prior to pick-up. As a person of skill in the art with the benefit of this disclosure would recognize, additional fields may be provided for e-mail addresses and additional phone numbers, and/or selection of a customer's preferred type of message.

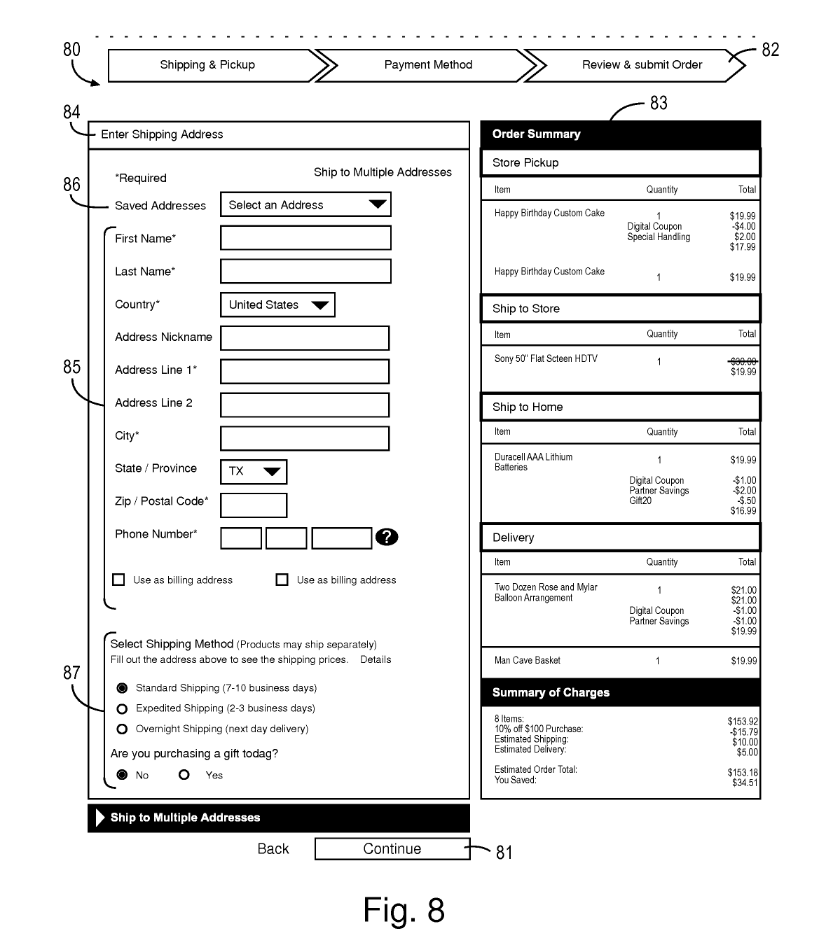

Referring now to FIG. 8, checkout display 80 further includes active area 84 listing the items selected for ship-to-home fulfillment. Active area 84 may include one or more fields 85 for the user to enter the shipping recipient's name, address, and phone numbers. In some instances, a particular recipient and their address/phone number information may be entered by the customer for a particular order, or may be automatically populated with information associated with a customer's past purchase history and/or registered account with the retailer (to which the customer has “logged in” for the session in which the order is being created). In certain embodiments, a saved addresses picker 86 may be provided that, which clicked or activated by the customer, may open a drop-down menu (not shown) listing one or more recipients and their respective address/phone number information that may have been saved to the active customer account or profile. The customer can click on or activate one of the recipients listed in the drop-down menu, which will automatically populate fields 85 with the corresponding information. Active area 84 also includes one or more shipping method options 86, which may be selected by the user by clicking on the desired option, or automatically selected by the retailer. Alternatively, if the customer wishes to have various items selected for ship-to-home fulfillment shipped to multiple different addresses, the customer may click or activate the “Ship to Multiple Addresses” hyperlink 88. In certain embodiments, clicking or activating hyperlink 88 will open a new display (not shown) similar to display 80 that includes an active areas for each item designated for ship-to-home fulfillment, each of which includes the same fields shown in active area 84.

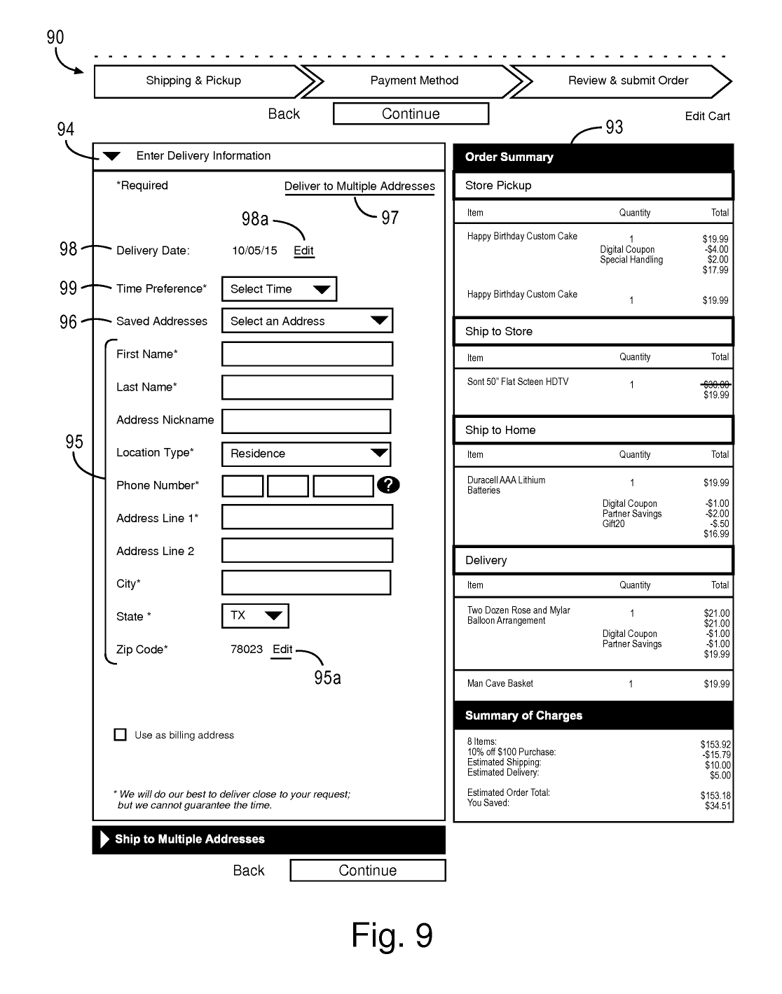

Referring now to FIG. 9, checkout display 90 further includes active area 94 listing the items selected for home delivery fulfillment. Active area 94 may include one or more fields 95 for the user to enter the shipping recipient's name, address, location type, and phone numbers. In some instances, a particular recipient and their address/phone number information may be entered by the customer for a particular order, or may be automatically populated with information associated with a customer's past purchase history and/or registered account with the retailer (to which the customer has “logged in” for the session in which the order is being created). As shown in the lower portion of area 94, the zip code is already displayed and does not include a field for customer input. In this embodiment, this zip code corresponds to the zip code selected or confirmed by the customer in FIG. 2 (or when the item was placed in the customer's cart) before proceeding to the checkout phase. If the customer wishes to change the delivery to a different zip code at display 90, the customer can click the Edit zip code hyperlink 95a, which, for example, may cause the client system to display a screen similar to display 20 shown and discussed previously in FIG. 2 where the customer can enter a new zip code. The retail server system will confirm whether the item(s) are available for delivery in the new zip code, in a manner similar to that discussed previously with respect to FIG. 2, before the customer can proceed beyond display 90.

Referring back to FIG. 9, in certain embodiments, a saved addresses picker 96 may be provided in active area 94 that, which clicked or activated by the customer, may open a drop-down menu (not shown) listing one or more recipients and their respective address/phone number information that may have been saved to the active customer account or profile. The customer can click on or activate one of the recipients listed in the drop-down menu, which will automatically populate fields 95 with the corresponding information. Alternatively, if the customer wishes to have various items selected for home delivery delivered to multiple different addresses, the customer may click or activate the “Deliver to Multiple Addresses” hyperlink 97. In certain embodiments, clicking or activating hyperlink 97 will open a new display (not shown) similar to display 90 that includes an active areas for each item designated for ship-to-home fulfillment, each of which includes the same fields shown in active area 94.

As shown in the upper portion of area 94, the delivery date 98 is already displayed and does not include a field for customer input. In this embodiment, this delivery date corresponds to the delivery selected or confirmed by the customer in FIG. 2 (or when the item was placed in the customer's cart) before proceeding to the checkout phase. If the customer wishes to change the delivery to a different date at display 90, the customer can click the Edit delivery date hyperlink 98a, which, for example, may cause the client system to display a screen similar to display 20 shown and discussed previously in FIG. 2 where the customer can enter or select a new delivery date. The retail server system will confirm whether the item(s) are available for delivery on the new delivery date, in a manner similar to that discussed previously with respect to FIG. 2, before the customer can proceed beyond display 90. Finally, active area 94 also includes a delivery time picker 99. Clicking on delivery time picker 99 may open a new display or a drop-down menu (not shown) displaying available delivery time options from which the customer may select. In other embodiments (or if the customer fails to select a delivery time), the retailer server system may automatically select a delivery time.

As described above, checkout displays 70, 90, and 90 display information relating to each item in the customer's order and prompt the customer to provide additional information for the various fulfillment channels for his order. Once the customer has provided the information for each display and method of fulfillment, the customer clicks the “Continue” button on each display to proceed to the next display. For example, in the embodiment shown, clicking the “Continue” button 71 on display 70 causes the client system to send the information entered by the customer to the retailer server system and proceed to display 80, clicking the “Continue” button 81 on display 80 causes the client system to send the information entered by the customer to the retailer server system and proceed to display 90, and clicking the “Continue” button 91 on display 90 causes the client system to send the information entered by the customer to the retailer server system and proceed to display 100 as shown in FIG. 10. In certain embodiments, the checkout displays 70, 80, and/or 90 also may be displayed to the customer in any order selected by the retailer.

In certain embodiments, the online retail systems of the present disclosure may be configured to display only the checkout displays applicable to the fulfillment channels used in the current order and “skip” checkout displays for fulfillment channels not selected in a particular order. For example, in the embodiment shown, the order includes items that are fulfilled using four different fulfillment channels: ship-to-store, in-store pick-up, ship-to-home, and home delivery. Thus, checkout displays 70, 80, and 90 are all used and displayed in the described embodiment. However, in another embodiment, if a particular customer's order only includes items to be fulfilled via ship-to-store and home delivery channels, a customer using the system of the present disclosure depicted will complete the information requested in checkout display 70, and then when the customer clicks “Continue” button 71, the system will proceed to checkout display 90 for the delivery items, and display 80 may not be displayed to the customer. In other embodiments, depending on the fulfillment channels selected for a particular only one of checkout displays 70, 80, and 90 may be displayed. This design may, among other benefits, provide for a more satisfying and/or efficient shopping experience for the customer while allowing the retailer to process orders via multiple fulfillment channels using a single, flexible system.

Referring now to FIG. 10, payment information display 100 may be displayed at the client system once the customer clicks or activates the last “Continue” button 91 in the checkout phase (or 71 or 81, depending on the embodiment). Similar to checkout displays 70, 80, and 90, payment display includes a progress bar 102 with the same sections discussed above (the “Payment Method” section now highlighted to indicate the customer's progress), one or more “Continue” buttons 101 (that operate in a manner similar to those previously described), and an order summary section 103 that shows all of the items in the customer's order grouped by their selected fulfillment channels, including information about each of those items (some of which may have been updated in checkout displays 70, 80, and/or 90), and the total cost for all of the items in the cart as well as their total shipping and/or delivery costs. Moreover, display 100 also includes a store location listing 107 (showing the final store location confirmed in FIG. 7), as well as an “Edit” hyperlink 108, which operate in a fashion similar to listing 17 and hyperlink 18 in FIG. 1. In certain embodiments, if the order does not include any items fulfilled via ship-to-store or in-store pick-up channels, store location listing 107 and hyperlink 108 may be suppressed in display 100.

Display 100 also includes an active area 104 including a number of fields and selectors for the customer to provide or select payment information for all of the items in the order together. The payment information display 100 and its fields may vary depending on the implementation, and may be chosen, displayed, formatted, and/or configured in any manner suitable in the art for accepting payment information via an online system (with known privacy safeguards as appropriate or desired). Moreover, as one skilled in the art will recognize with the benefit of this disclosure, an online retail system of the present disclosure may be configured or designed without a payment information display, for example, if the system is configured to automatically apply one or more methods of payment previously selected by the customer and associated with or saved on the customer's registered account with the retailer (to which the customer has “logged in” for the session in which the order is being created).

In the embodiment shown, display 100 includes a section 105 with fields for receiving information relating to giftcards and sections 109 and 110 with fields for receiving information input by the customer relating to credit cards and/or debit cards and their associated billing information. In certain embodiments, display 100 also includes a section 106 for selecting a credit card or debit card previously entered by the customer and/or saved on the customer's registered account with the retailer (to which the customer has “logged in” for the session in which the order is being created).

In the embodiment shown, after the consumer clicks or activates the “Continue” button 101 in payment display 100, the client system sends the information entered by the customer to the retailer server system, and may proceeds to display review/submit order display 130 as shown in FIG. 11. Similar to the checkout and payment information displays, display 130 includes a progress bar 132 with the same sections discussed above (the “Review & Submit Order” section now highlighted to indicate the customer's progress), and a store location listing 137 (showing the final store location confirmed in FIG. 7), as well as an “Edit” hyperlink 138, which operate in a fashion similar to listing 17 and hyperlink 18 in FIG. 1, or may be suppressed or omitted if the order does not include any items fulfilled via ship-to-store or in-store pick-up channels. Display 130 includes a listing 134 of the items in the order grouped by fulfillment channel, which lists details pertaining to the items and their fulfillment channel, including pick-up and delivery dates/times, delivery and shipment addresses, customer phone numbers, and the like. Display 130 also includes a summary of charges 139 showing the total cost for all of the items in the order as well as their total shipping and/or delivery costs. Certain payment information 136 is also displayed on display 130, although full payment details may be omitted to protect the customer's privacy and payment information. Display 130 also includes a “Submit Order” button 131. Once the customer has reviewed the information pertaining to the order and has confirmed its accuracy, the customer clicks or activates this button 131, the client system re-sends or confirms the order information to the retailer server system for final validation, and the retailer server system pre-authorizes the selected payment methods per known methods. The retail server system accepts the completed order, creates a data file or record for the order (e.g., in an order database on the retailer's server system (e.g., one or more of retail server systems 230 and 237)), and processes it for fulfillment according to the methods of the present disclosure.

The retail server system may authorize and/or settle payment for the order (e.g., the cost of items in the order and/or any applicable shipping or delivery costs) according to any suitable method. As referenced above, the retail server system may pre-authorize the payment methods selected by the user, which may be in the total amount for all costs in the order, or alternatively only for the costs for certain items in the order. In certain embodiments, payment for the order may be settled according to certain generally-accepted accounting principles applicable to the fulfillment channels in the order. For example, payment for items fulfilled via ship-to-home or ship-to-store channels may be settled once the items are tendered to a third-party carrier for shipment, while payment for items fulfilled via in-store pick-up or home delivery channels may be settled once the items are actually tendered to and accepted by the customer (either directly or via the customer's designee). Thus, the payment for costs of different items (and their associated delivery/shipment costs) within a single order may be settled at different times and/or based on different events or criteria.

As noted with respect to FIG. 13, in the methods and systems of the present disclosure, information regarding a completed order including items to be fulfilled via two or more different fulfillment channels is submitted to the retailer server system either directly from the client system or via one or more third party providers' server systems. The retailer's server system may create one or more data files or records containing information about the ordered items grouped at least in part based on the selected fulfillment channel. Data records, files, or requests relating to items ordered for fulfillment via ship-to-home and/or ship-to store methods may be sent via communication connections and/or networks to one or more warehouse management servers or computer systems so that personnel and/or automated systems connected to or accessing the warehouse management server can take the necessary steps to fulfill those items. Similarly, data records, files, or requests relating to items ordered in the same order for fulfillment via in-store pick-up and/or home delivery methods may be sent via communication connections and/or networks to one or more store management servers or computer systems (e.g., a server or computer system operated or located at a store selected by the customer during the order process) so that personnel and/or automated systems connected to or accessing the store management server or computer system can take the necessary steps to fulfill those items.

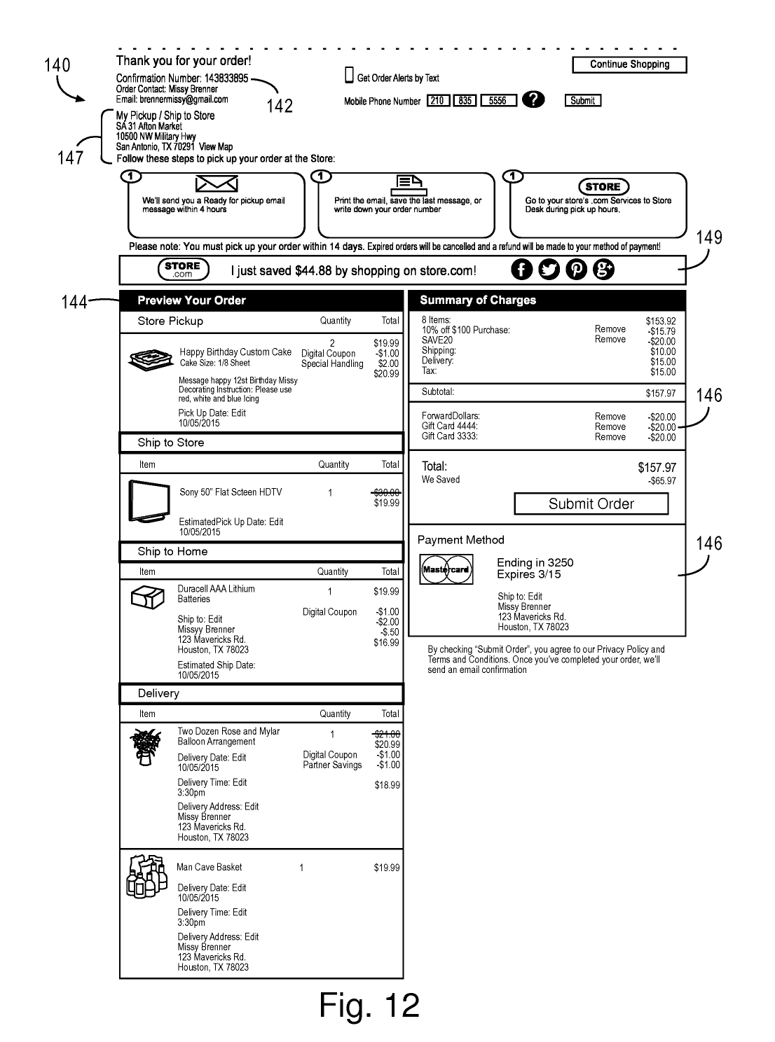

Finally, an optional order confirmation statement such as order confirmation display 140 is shown in FIG. 12. The order confirmation display 140 and its configuration may vary depending on the implementation, and may be chosen, displayed, formatted, and/or configured in any manner suitable in the art for displaying order information via an online system (with known privacy safeguards as appropriate or desired). In the embodiment shown, order confirmation display 140 includes a listing 144 of all of the items in the order grouped by fulfillment channel, as well as a summary of charges 149 and payment information 146 as described above. Order confirmation display 140 also includes a store location listing 147 for items designated for in-store pick-up and/or ship-to-store fulfillment (which may be suppressed if neither of those fulfillment channels are used in a customer's order). The order confirmation display 140 also includes a confirmation number 142 for identifying the order, as well as additional identifying information for the customer, instructions for picking up items, instructions for checking on the status of the order or receiving alerts relating thereto, and the like.

However, as one skilled in the art will recognize with the benefit of this disclosure, an online retail system of the present disclosure may be configured or designed without a review/submit order display, for example, if the system is configured to submit the customer's order to the retailer server system for processing and fulfillment in response to an earlier action or input by the customer. Moreover, an online retail system of the present disclosure may be configured or designed without an order confirmation display, for example, if the details of the order are sent to the customer (if at all) in a confirmation statement by some other means such as e-mail, hard copy, etc.

In certain embodiments, even after an order is submitted and/or confirmed, the fulfillment channel assigned to an item by the retailer, the user, and/or the system of the present disclosure may be changed or re-assigned (by the customer and/or the retailer) at any time before the item is actually provided to the customer, for example, by accessing and modifying part of the data file or record associated with the order. In other embodiments, the retailer may intentionally fulfill one or more items in an order via a fulfillment channel other than the assigned fulfillment channel without modifying the data record for the order for a variety of reasons such as product availability and the like. The systems that may be used and/or operated by retailers and/or customers in such a manner are still contemplated by and within the spirit of the present disclosure and claims, as long as they nonetheless embody the features and capabilities described and claimed herein.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
receiving data regarding a plurality of items selected for purchase from a retailer by a customer in an order, wherein one or more possible fulfillment channels are associated with each of the items;
assigning a fulfillment channel for each of the items in the order, wherein at least two different fulfillment channels are assigned within the order;
receiving payment information from the customer for the order; and
retrieving and/or preparing the items in the order for fulfillment to the customer via at least two different fulfillment channels.

2. The method of claim 1 wherein the items in the order are selected for purchase from and fulfillment to the customer by a single retailer.

3. The method of claim 1 further comprising providing items in the order to the customer or a third-party carrier via the at least two different assigned fulfillment channels.

4. The method of claim 1 wherein the fulfillment channel for at least one of the items in the order is assigned based on the selection of fulfillment channels by the customer.

5. The method of claim 1 wherein the fulfillment channel for at least one of the items in the order is assigned automatically based on a default fulfillment channel selected by the retailer for the item.

6. The method of claim 1 wherein:
the method further comprises determining a least cost fulfillment channel for at least one of the items in the order; and
the fulfillment channel assigned for at least one of the items in the order is the least cost fulfillment channel.

7. The method of claim 1 wherein:
the method further comprises determining a least cost fulfillment channel for the plurality of items in the order; and
the fulfillment channel assigned for each of the plurality of items in the order is the least cost fulfillment channel.

8. The method of claim 1 wherein the data regarding the plurality of items in the order is received via an online communication network through which a client system operated by the customer communicates with a retail server system operated by or on behalf of the retailer.

9. The method of claim 1 further comprising transmitting data for displays to the customer, wherein at least one of the displays includes information regarding all items in the order.

10. The method of claim 1 further comprising calculating a total cost of the items in the order.

11. The method of claim 1 further comprising calculating costs of delivery and/or shipping associated with the fulfillment channels assigned for the items in the order.

12. The method of claim 1 further comprising settling payment for the order based on generally-accepted accounting principles.

13. The method of claim 1 further comprising:
tendering a first item in the order to the customer for acceptance;
tendering a second item in the order to a third-party carrier for shipment;
settling payment for the first item when the first item is accepted by the customer; and
settling payment for the second item when second item is tendered to the third-party carrier.

14. The method of claim 13 wherein the fulfillment channel assigned for at least the first item is in-store pick-up or home delivery, and the fulfillment channel assigned for at least the second item is ship-to-store or ship-to-home fulfillment.

15. The method of claim 1 further comprising sending the customer an order confirmation statement for all items in the order.

16. The method of claim 15 wherein the confirmation statement comprises an order confirmation display that is displayed on a client system operated by the customer.

17. A computer program stored in a tangible medium for accepting and processing online retail orders comprising a plurality of instructions that when executed cause at least one processor to:
receive data regarding a plurality of items selected for purchase from a retailer by a customer in an order, wherein one or more possible fulfillment channels are associated with each of the items;
assign a fulfillment channel for each of the items in the order, wherein at least two different fulfillment channels are assigned within the order;
receive payment information from the customer for the order; and
create a request for retrieval and/or preparation the items in the order for fulfillment to the customer via at least two different fulfillment channels.

18. An online retail order system comprising:
a data server that comprises
at least one processor,
a communications interface configured to receive data from one or more client systems, and
a memory comprising executable instructions that, when executed, cause the at least one processor to:
receive data regarding a plurality of items selected for purchase from a retailer by a customer in an order, wherein one or more possible fulfillment channels are associated with each of the items;
assign a fulfillment channel for each of the items in the order, wherein at least two different fulfillment channels are assigned within the order;
receive payment information from the customer for the order; and
create a request for retrieval and/or preparation the items in the order for fulfillment to the customer via at least two different fulfillment channels.

19. The system of claim 18 wherein:
the executable instructions, when executed, further cause the at least one processor to determine a least cost fulfillment channel for at least one of the items in the order; and
the fulfillment channel assigned for at least one of the items in the order is the least cost fulfillment channel.

20. The system of claim 18 wherein the items in the order are selected for purchase from and fulfillment to the customer by a single retailer.
